(19) United States
(12) Patent Application Publication
(10) Pub. No.: US 2007/0174044 A1
(43) Pub. Date: Jul. 26, 2007

(54) Pedagogically integrated method for the teaching of enhanced reading skills by computer-aided and web-based instruction

(76) Inventor: Richard K. Sutz, Scottsdale, AZ (US)

Correspondence Address: TOD R NISSLE, PO BOX 55630, PHOENIX, AZ, 85078, US

(21) Appl. No.: 11/267,016

(22) Filed: Nov. 3, 2005

Related U.S. Application Data
(60) Provisional application No. 60/625,011, filed on Nov. 3, 2004.

(51) Int. Cl. G06F 17/28

(52) U.S. Cl. 704/4

(57) ABSTRACT

A computer program for improving reading speed includes a list of prime words and reading exercising utilizing the prime words.

This patent application claims priority on provisional patent application Ser. No. 60/625,011 filed Nov. 3, 2004.

A computer program is provided to improve reading skills. The program can be viewed and used by employing any desired means, including a desk top computer or a web site on the Internet.

One feature of the program is that it utilizes the concept of silent fluency in reading. Silent fluency means the user reads a selected number of words with a single eye fixation and without vocalizing the words. The program displays various words or phrases or sentences and asks or trains the user to with a single eye fixation see and comprehend the words or phrases or sentences. The program can display for a selected period of time phrases that are two to eight words long, or that are any other desired length. After the phrases are displayed, a question is asked to determine if the reader successfully read and comprehended the phrase in the time allowed. The length of time that the phrase is displayed is controlled by the user. If the user is having a difficult time comprehending phrases that are eight words long, the user can use the program to increase the length of time that the phrases on are the computer screen, or can shorten the length of the phrases.

The program preferably utilizes prime words in the phrases and sentences read by a user. Prime words are words that are immediately recognizable to most people, that don't need decoding, and that the user's eye ordinarily does not fixate on. Less than about 2000 words constitute 70% of everything in print. In the program of the invention, using prime words, or utilizing words or phrases or sentences that consist in large part of prime words, facilitates an individual's learning to read. Examples of prime words are “cat”, “dog”, months of the year, common names in the English language, colors, temperatures, seasons of the year, “apple”, “orange”. In addition to prime words, each vocational area has its own vocabulary or “custom words”. With a vocabulary of about 2000 common prime words and 500 custom words in an individual's vocation area, 90% of what the individual would read would be readily recognizable. One feature of the program of the invention is that it includes custom words for various vocations.

Another feature of the program of the invention is that a table of contents or navigation flow chart is continuously displayed on a portion of the screen so that the user reader at all times knows where he or she is going or is in the program.

People learn visually, orally and kinesthetically. The program of the invention permits user to utilize any of those three tendencies. The program has a genie or other character that talks to the user. The user can disable the genie if the user wishes. The continuously visible table of contents provides visual input. The use of multiple choice questions provides kinesthetic feedback by validating what the user thought he or she read on the computer screen. However, when the program gives the user a multiple choice question, if the user gets one wrong, the user gets another chance. If the user gets it wrong a second time, the computer gives the correct answer because the computer is teaching and not testing. The computer keeps track of the number of correct answers and at appropriate times feeds this information kinesthetically back to the user. The user can, if desired, disable the test questions such that the user does not have to view or answer such questions.

The position of window that displays words, phrases, etc. to be read is adjustable. The window can, for example, be elongated to spread out words and improve the peripheral vision used by an individual who is attempting to read words or phrases or sentences.

The reading exercises provided by the program are arranged in sequential order. The best way to teach is to instill in student a level of confidence that they can learn whatever is being taught. The first recommending exercise has the user read words positioned along a horizontal line. This exercise is used to demonstrate to a user that the user can read 3 to 5 times faster if the user doesn't vocalize. Other exercises in the program require the user to read words that are “stacked” vertically on top of each other, in the same manner that parallel, spaced apart typewritten lines on a page of a book are stacked one on top of the other.

The program permits the user to import reading material that interests the user.

The program can use words in a sentence such that the meaning of the word is deduced from the context of the word in the sentence.

As suggested above, one important feature of the program of the invention is that the user of the program controls each aspect of the program. The user can determine if he wishes to use oral or kinesthetic feedback, can determine the lengths of phrases or sentences to be read, can determine how quickly the user has to read a phrase or sentence, etc.

A description of a sample program is attached to illustrate some of the above-noted features.

1. A computer program for improving reading speed comprising
a. A list of prime words; and,
b. Reading exercises utilizing said prime words.
